(19) United States
(12) Patent Application Publication
(10) Pub. No.: US 2010/0033456 A1
(43) Pub. Date: Feb. 11, 2010

(54) DISPLAY DEVICE AND DISPLAY METHOD THEREOF

(76) Inventors: Keisuke Yoshida, Osaka (JP); Mutsumi Nakajima, Osaka (JP)

Correspondence Address: HARNESS, DICKEY & PIERCE, P.L.C., P.O. BOX 8910, RESTON, VA, 20195, US

(21) Appl. No.: 12/450,722

(22) PCT Filed: Feb. 28, 2008
(86) PCT No.: PCT/JP2008/053475

§ 371 Date: Oct. 9, 2009

(30) Foreign Application Priority Data
May 14, 2007 (JP) 2007-127535

(51) Int. Cl. G09G 5/10; G06F 3/038

(52) U.S. Cl. 345/207; 345/690

(57) ABSTRACT

An object of the present invention is to provide a display device that achieves a balance between color reproducibility and luminance under the premise that the display device uses a display panel in which each pixel is configured by sub-pixels of four or more colors. An outside light detecting unit (500) outputs a current Ia according to the intensity of outside light. A switching control circuit (600) outputs a display mode selection signal (S) for selecting a display mode, based on the magnitude of the current (Ia). An output selection circuit (120) provides RGB image signals to an input selection circuit (160) when in a first display mode (when it is dark) and provides RGB image signals to a gray scale value converting unit (140) when in a second display mode (when it is bright). In the first display mode, a W image signal generated by a black signal generation circuit (130) is used as a gray scale signal (DV). In the second display mode, a W image signal generated by the gray scale value converting unit (140) referring to a gray scale value determination table (150) is used as a gray scale signal (DV).

### TECHNICAL FIELD

The present invention relates to a display device, and more particularly to a display device including a display panel in which each pixel is configured by sub-pixels of four or more colors.

### BACKGROUND ART

Conventionally, in liquid crystal display devices, color filters of three colors, red, green, and blue (RGB), are used to perform color image display. In such liquid crystal display devices, as shown in FIG. 15A, one pixel is configured by pixels of three colors, red, green, and blue (each pixel is referred to as a “sub-pixel”). By controlling the transmittance on a sub-pixel-by-sub-pixel basis, a desired color is displayed in each pixel. In recent years, there has been an increasing demand for widening the color reproducibility range (increasing color reproducibility) in such liquid crystal display devices. Also, occasions where liquid crystal display devices such as portable electronic devices are used outdoors have increased. Because of this, there has also been an increasing demand for increasing luminance so as to maintain excellent visibility even in an environment where outside light is strong. Note that in the following description red, green, and blue are respectively abbreviated as R, G, and B. Note also that, for example, a “red image signal” is referred to as an “R image signal”.

Meanwhile, when the colors of color filters are deepened to widen the color reproducibility range, transmittance decreases and thus luminance decreases. In view of the above, a liquid crystal display device is proposed in which one pixel is configured by sub-pixels of four colors to suppress a decrease in luminance. For example, a liquid crystal display device in which, as shown in FIG. 15B, a sub-pixel of white (W) is added to sub-pixels of three primary colors RGB is known. According to the liquid crystal display device, by allowing light to transmit through the sub-pixel of W, a luminance that is about 1.5 times higher than that obtained by a liquid crystal display device in which one pixel is configured by sub-pixels of three primary colors RGB can be obtained.

Note that Japanese Patent Application Laid-Open No. 2003-241165 discloses an invention pertaining to a liquid crystal display device including a drive means that configures one frame by three RGB fields; and a drive means that configures one frame by four RGBW fields. In the liquid crystal display device, by switching between the drive means according to brightness, switching between image display using three colors RGB and image display using four colors RGBW is performed.

[Patent Document 1] Japanese Patent Application Laid-Open No. 2003-241165

### DISCLOSURE OF THE INVENTION

### Problems to be Solved by the Invention

However, when single color display or display close thereto is performed in a liquid crystal display device in which one pixel is configured by sub-pixels of four colors, luminance decreases over the case in which the same display is performed in a liquid crystal display device in which one pixel is configured by sub-pixels of three colors. The reason for this is as follows. When single color display is performed in a liquid crystal display device having sub-pixels of four colors, for example, RGBW, sub-pixels of W provide black display. Taking a look at the entire aperture area of one pixel, the aperture area is smaller in the liquid crystal display device having sub-pixels of four colors than in the liquid crystal display device having sub-pixels of three colors. As such, as long as one pixel is configured by sub-pixels of four colors, a decrease in luminance upon single color display is unavoidable and thus it is difficult to satisfy both high color reproducibility and high luminance at all times. Also, the invention of a liquid crystal display device disclosed in the aforementioned Japanese Patent Application Laid-Open No. 2003-241165 is applied to liquid crystal display devices that perform color display by a field sequential scheme and is not applied to liquid crystal display devices that perform color display with pixels being spatially divided.

In view of the above, an object of the present invention is to provide a display device that achieves a balance between color reproducibility and luminance under the premise that the display device uses a display panel in which one pixel is configured by sub-pixels of four or more colors.

### Means for Solving the Problems

A first aspect of the present invention is directed to a display device that includes a display unit having a plurality of video signal lines and pixels, each of which is configured by sub-pixels of four or more colors including three colors, red, green, and blue, and that displays an image on the display unit by applying driving video signals generated based on gray scale values of the respective sub-pixels, to the plurality of video signal lines, the display device including:

an outside light detecting unit for detecting an intensity of outside light;

a display mode selecting unit for selecting one of a first display mode and a second display mode according to the intensity of outside light detected by the outside light detecting unit, the first display mode where image display is performed such that a gray scale value of a sub-pixel of at least one color among sub-pixels of colors other than the three colors, red, green, and blue, is a predetermined value, the second display mode where image display is performed such that a gray scale value of a sub-pixel of a color other than the three colors, red, green, and blue, is a value determined based on gray scale values indicated by RGB image signals sent from an external source;

a gray scale signal generating unit for receiving the RGB image signals and generating, according to the display mode selected by the display mode selecting unit, gray scale signals indicating gray scale values of the respective sub-pixels; and

a video signal line drive circuit for applying the driving video signals to the plurality of video signal lines based on the gray scale signals generated by the gray scale signal generating unit, wherein

the display mode selecting unit selects the first display mode when the intensity of outside light is less than a predetermined reference intensity, and selects the second display mode when the intensity of outside light is greater than or equal to the reference intensity.

According to a second aspect of the present invention, in the first aspect of the present invention,

when the first display mode is selected by the display mode selecting unit, the gray scale signal generating unit generates the gray scale signals such that a gray scale value of a sub-pixel of at least one color among sub-pixels of colors other than the three colors, red, green, and blue, is a value corresponding to black display.

According to a third aspect of the present invention, in the first aspect of the present invention,

each of the pixels configuring the display unit is configured by sub-pixels of red, green, blue, and white.

According to a fourth aspect of the present invention, in the first aspect of the present invention,

each of the pixels configuring the display unit is configured by sub-pixels of red, green, and blue and a sub-pixel of at least one of yellow and cyan.

According to a fifth aspect of the present invention, in the first aspect of the present invention,

the display device further includes a gray scale value determination table for storing information indicating a correspondence relationship between the gray scale values indicated by the RGB image signals and a gray scale value of a sub-pixel of a color other than the three colors, red, green, and blue, among the sub-pixels of four or more colors, wherein

when the second display mode is selected by the display mode selecting unit, the gray scale signal generating unit generates the gray scale signals based on the gray scale value determination table.

According to a sixth aspect of the present invention, in the fifth aspect of the present invention,

the gray scale value determination table further stores information indicating a correspondence relationship between the gray scale values indicated by the RGB image signals and gray scale values of sub-pixels of red, green, and blue.

According to a seventh aspect of the present invention, in the fifth aspect of the present invention, the display device further includes a plurality of gray scale value determination tables, wherein

when the second display mode is selected by the display mode selecting unit, the gray scale signal generating unit selects any one of the plurality of gray scale value determination tables according to the intensity of outside light and generates the gray scale signals based on the selected gray scale value determination table.

According to an eighth aspect of the present invention, in the first aspect of the present invention,

the outside light detecting unit is a photodiode or phototransistor.

A ninth aspect of the present invention is directed to a display method for a display device that includes a display unit having a plurality of video signal lines and pixels, each of which is configured by sub-pixels of four or more colors including three colors, red, green, and blue, and that displays an image on the display unit by applying driving video signals generated based on gray scale values of the respective sub-pixels, to the plurality of video signal lines, the display method including:

an outside light detecting step of detecting an intensity of outside light;

a display mode selecting step of selecting one of a first display mode and a second display mode according to the intensity of outside light detected in the outside light detecting step, the first display mode where image display is performed such that a gray scale value of a sub-pixel of at least one color among sub-pixels of colors other than the three colors, red, green, and blue, is a predetermined value, the second display mode where image display is performed such that a gray scale value of a sub-pixel of a color other than three colors, red, green, and blue, is a value determined based on gray scale values indicated by RGB image signals sent from an external source;

a gray scale signal generating step of receiving the RGB image signals and generating, according to the display mode selected in the display mode selecting step, gray scale signals indicating gray scale values of the respective sub-pixels; and

a video signal line driving step of applying the driving video signals to the plurality of video signal lines based on the gray scale signals generated in the gray scale signal generating step, wherein

in the display mode selecting step, the first display mode is selected when the intensity of outside light is less than a predetermined reference intensity and the second display mode is selected when the intensity of outside light is greater than or equal to the reference intensity.

Also, variants grasped by referring to embodiments and the drawings in the ninth aspect of the present invention are considered to be means for solving the problem.

### EFFECTS OF THE INVENTION

According to the first aspect of the present invention, a first display mode where the gray scale value of a sub-pixel of at least one color is a predetermined value and a second display mode using all sub-pixels of four or more colors for gray scale display are provided. Selection of the display modes is made based on the intensity of outside light. Then, when the intensity of outside light is less than a reference intensity, image display is performed in the first display mode, and when the intensity of outside light is greater than or equal to the reference intensity, image display is performed in the second display mode. Hence, when the display device is used in a dark environment, by setting the predetermined value to decrease luminance, such image display that can obtain excellent color reproducibility is performed. On the other hand, when the display device is used in a bright environment, by using all sub-pixels to perform gray scale display, image display with increased luminance is performed. Accordingly, switching between image display where color reproducibility is given priority over luminance and image display where luminance is given priority over color reproducibility can be effectively performed according to the environment where the display device is used.

According to the second aspect of the present invention, when the first display mode is selected by the display mode selecting unit, a sub-pixel of at least one color is fixed to black display. Thus, when the display device is used in a dark environment, a well-defined image with deep colors is displayed.

According to the third aspect of the present invention, in a display device having a sub-pixel of white, as with the first aspect, switching between image display where color reproducibility is given priority over luminance and image display where luminance is given priority over color reproducibility can be effectively performed according to the environment where the display device is used.

According to the fourth aspect of the present invention, in a display device having a sub-pixel of yellow or cyan, as with the first aspect, switching between image display where color reproducibility is given priority over luminance and image display where luminance is given priority over color reproducibility can be effectively performed according to the environment where the display device is used.

According to the fifth aspect of the present invention, the gray scale value of a sub-pixel of a color other than three primary colors, red, green, and blue, is determined based on a gray scale value determination table. Hence, by minutely setting the gray scale value of a sub-pixel of a color other than the three primary colors, taking into account color reproducibility and luminance, more favorable image display is performed. In addition, by changing the values in the gray scale value determination table, color adjustment is easily performed.

According to the sixth aspect of the present invention, the gray scale values of sub-pixels of three primary colors, red, green, and blue, are also determined based on the gray scale value determination table. Hence, the gray scale values of the sub-pixels of the three primary colors can also be minutely set in advance and thus more favorable image display is performed.

According to the seventh aspect of the present invention, a plurality of gray scale value determination tables are held in advance. Upon generation of gray scale signals, a gray scale value determination table is referred to according to the intensity of outside light. Hence, the intensity of outside light is divided into a plurality of levels and gray scale value determination tables having different settings according to the levels can be referred to. Accordingly, more favorable image display is performed according to the intensity of outside light.

According to the eighth aspect of the present invention, outside light received by the display device can be detected with a simple configuration.

### BRIEF DESCRIPTION OF THE DRAWINGS

FIG. 1 is a block diagram showing an overall configuration of a liquid crystal display device in a first embodiment of the present invention.

FIG. 2 is a circuit diagram showing configurations of an outside light detecting unit and a switching control circuit in the first embodiment.

FIG. 3 is a logic circuit diagram showing a configuration of an output selection circuit in the first embodiment.

FIGS. 4A and 4B are circuit diagrams showing configurations of a black signal generation circuit in the first embodiment.

FIG. 5 is a diagram showing an exemplary configuration of a gray scale value determination table in the first embodiment.

FIG. 6 is a logic circuit diagram showing a configuration of an input selection circuit in the first embodiment.

FIG. 7 is a block diagram showing a configuration of a first variant of the first embodiment.

FIG. 8 is a diagram showing an exemplary configuration of a W gray scale value determination table in the first variant.

FIG. 9 is a block diagram showing a configuration of a second variant of the first embodiment.

FIG. 10 is a diagram for describing a display mode selection signal in the second variant.

FIG. 11 is a block diagram showing an overall configuration of a liquid crystal display device in a second embodiment of the present invention.

FIG. 12 is a block diagram showing an overall configuration of a liquid crystal display device in a third embodiment of the present invention.

FIG. 13 is a diagram showing an exemplary configuration of an RGB gray scale value determination table in the third embodiment of the present invention.

FIG. 14 is a diagram showing an exemplary configuration of an RGBY gray scale value determination table in the third embodiment of the present invention.

FIGS. 15A to 15D are diagrams schematically showing configurations of pixels in a display unit of a liquid crystal display device.

### DESCRIPTION OF REFERENCE NUMERALS

100 . . . Gray scale signal generating unit
120 . . . Output selection circuit
130 . . . Black signal generation circuit
140 . . . Gray scale value converting unit
150 . . . Gray scale value determination table
160 . . . Input selection circuit
200 . . . Display unit
300 . . . Source driver (video signal line drive circuit)
400 . . . Gate driver (scanning signal line drive circuit)
500 . . . Outside light detecting unit
600 . . . Switching control circuit
DA . . . Digital image signal
DV . . . Gray scale signal
S . . . Display mode selection signal

### BEST MODE FOR CARRYING OUT THE INVENTION

Embodiments of the present invention will be described below with reference to the accompanying drawings.

### 1. First Embodiment

### 1.1 Overall Configuration and Operation

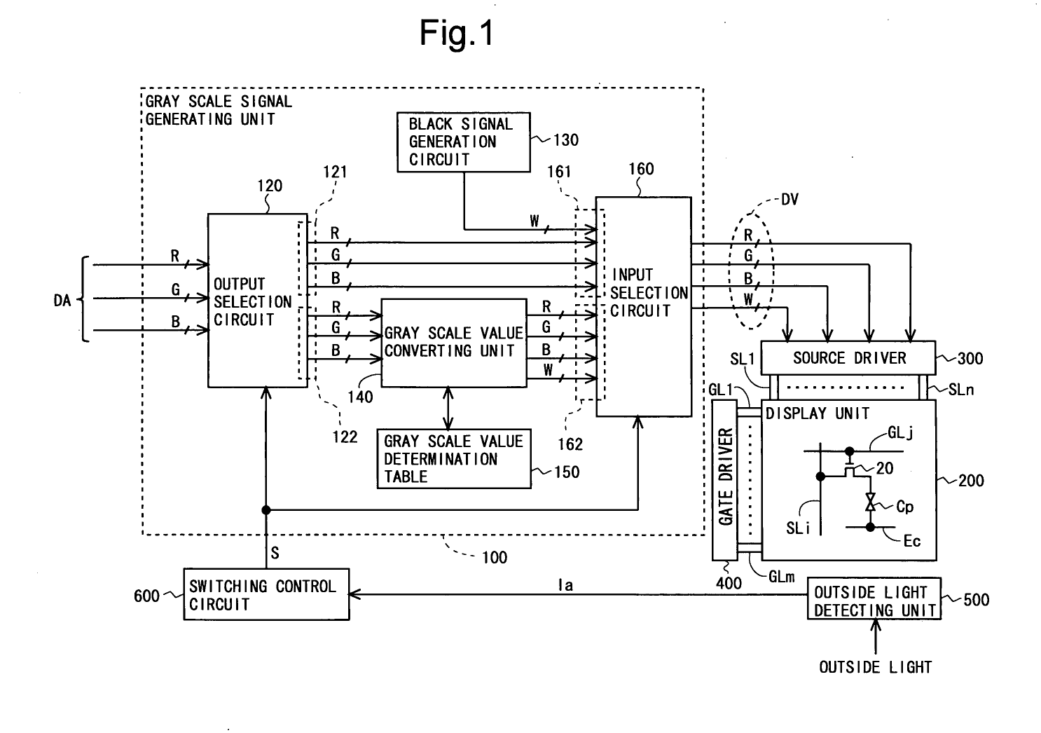

FIG. 1 is a block diagram showing an overall configuration of a liquid crystal display device according to a first embodiment of the present invention. The liquid crystal display device includes a gray scale signal generating unit 100, a display unit (display panel) 200, a source driver (video signal line drive circuit) 300, a gate driver (scanning signal line drive circuit) 400, an outside light detecting unit 500, and a switching control circuit 600.

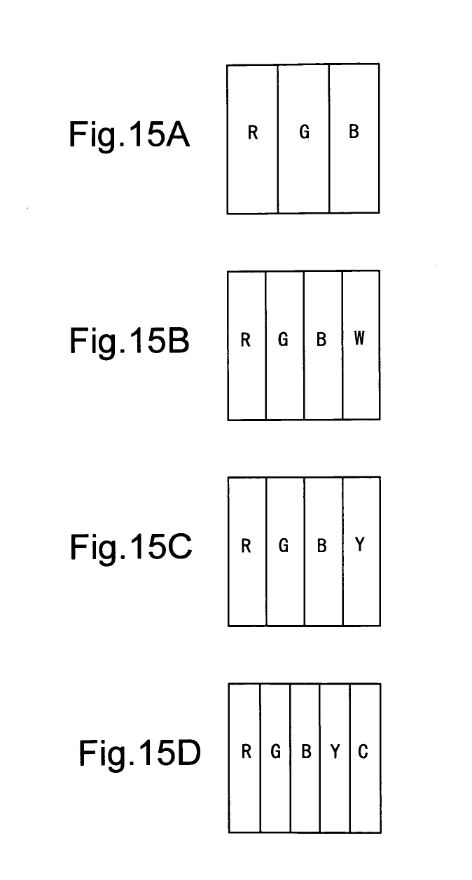

The display unit 200 includes a plurality of (n) source bus lines (video signal lines) SL1 to SLn, a plurality of (m) gate bus lines (scanning signal lines) GL1 to GLm, and a plurality of (n×m) pixel formation portions respectively provided at intersections of the plurality of source bus lines SL1 to SLn and the plurality of gate bus lines GL1 to GLm. The pixel formation portions are arranged in a matrix to configure a pixel array. Each pixel formation portion forms any one of predetermined colors, R (red), G (green), B (blue), and W (white). That is, in the present embodiment, as shown in FIG. 15B, one pixel is configured by sub-pixels of four colors RGBW.

Each pixel formation portion is configured by a TFT 20 which is a switching element having a gate terminal connected to a gate bus line GLj passing through a corresponding intersection and having a source terminal connected to a source bus line SLi passing through the intersection; a pixel electrode connected to a drain terminal of the TFT 20; a common electrode Ec which is a counter electrode provided for the plurality of pixel formation portions in a shared manner; and a liquid crystal layer provided for the plurality of pixel formation portions in a shared manner and sandwiched between the pixel electrode and the common electrode Ec. By a liquid crystal capacitance formed by the pixel electrode and the common electrode Ec, a pixel capacitance Cp is configured.

The outside light detecting unit 500 detects an intensity of outside light received by the liquid crystal display device, and outputs a current Ia of a magnitude according to the detected intensity of outside light. The switching control circuit 600 outputs a display mode selection signal S for selecting a display mode which will be described later, according to the magnitude of the current Ia outputted from the outside light detecting unit 500. The gray scale signal generating unit 100 receives digital image signals DA (RGB image signals) sent from an external source. The gray scale signal generating unit 100 further generates gray scale signals DV indicating the gray scale values of the respective RGBW colors and outputs the gray scale signals DV, based on the display mode selection signal S outputted from the switching control circuit 600. Note that the gray scale signal generating unit 100, the outside light detecting unit 500, and the switching control circuit 600 will be described in detail later. Note also that in the present embodiment a display mode selecting unit is implemented by the switching control circuit 600.

The source driver 300 receives the gray scale signals DV outputted from the gray scale signal generating unit 100 and a timing signal (for the source driver) outputted from a timing generator (not shown) and applies a driving video signal to each of the source bus lines SL1 to SLn to charge the pixel capacitance Cp of each pixel formation portion in the display unit 200. The gate driver 400 repeats an application of an active scanning signal to each of the gate bus lines GL1 to GLm in a cycle of one vertical scanning period, based on a timing signal (for the gate driver) outputted from the timing generator (not shown).

With such a configuration as described above, a driving video signal is applied to each of the source bus lines SL1 to SLn and a scanning signal is applied to each of the gate bus lines GL1 to GLm, whereby an image is displayed on the display unit 200. Note that, in the present embodiment, description is made assuming that the liquid crystal display device is of a normally white type and data of each of RGBW colors is 8 bits.

### 1.2 Display Mode

As described above, each pixel in the display unit 200 has a configuration shown in FIG. 15B. That is, each pixel is configured by sub-pixels of four colors RGBW. Meanwhile, in the present embodiment, two display modes (one is referred to as the “first display mode” and the other is referred to as the “second display mode”) are provided. One of the display modes is selected based on the intensity of outside light received by the outside light detecting unit 500.

In the “first display mode”, image display using three colors RGB is performed. Specifically, as for sub-pixels of three colors RGB among sub-pixels of four colors, a voltage is applied such that a desired transmittance can be obtained based on digital image signals DA sent from an external source, and gray scale display is performed by the application of a voltage. At this time, as for a sub-pixel of W, black display is performed regardless of the gray scale values of the three colors RGB. On the other hand, in the “second display mode”, image display using four colors RGBW is performed. Specifically, as for all sub-pixels of RGBW, a voltage is applied such that a desired transmittance can be obtained based on digital image signals DA sent from an external source, and gray scale display is performed by the application of a voltage.

### 1.3 Configurations and Operations of the Outside Light Detecting Unit and the Switching Control Circuit

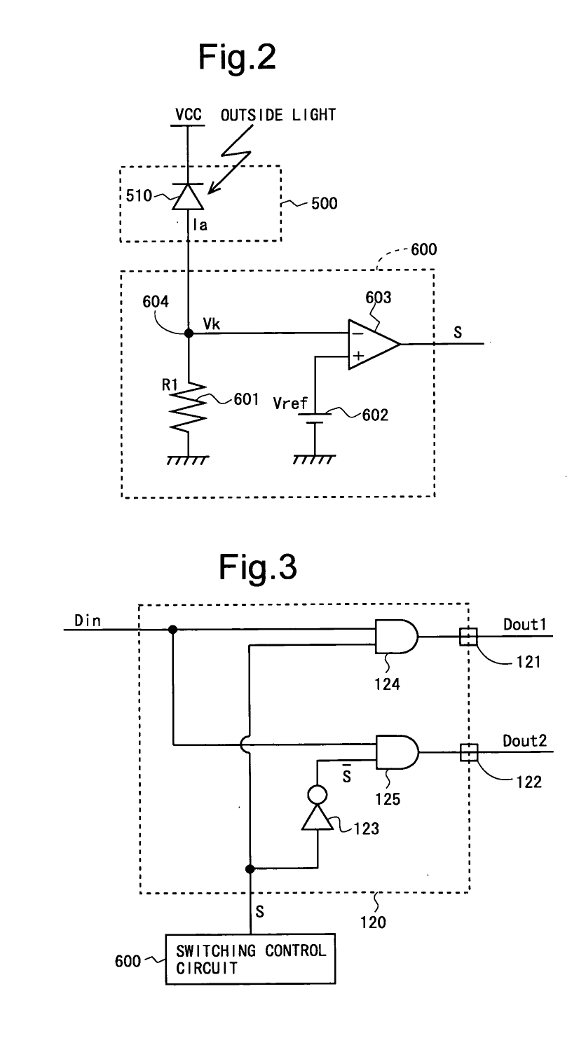

FIG. 2 is a circuit diagram showing configurations of the outside light detecting unit 500 and the switching control circuit 600. In the present embodiment, the outside light detecting unit 500 is configured by a photodiode 510. The switching control circuit 600 includes a resistor 601 having a resistance value R1; a power supply 602 that generates a predetermined reference voltage Vref; and a comparator 603 for comparing voltages. As shown in FIG. 2, the photodiode 510 and the resistor 601 are connected to each other in series and a voltage in a reverse direction is provided to the photodiode 510. A node 604 between the photodiode 510 and the resistor 601 is connected to an inverting input terminal of the comparator 603. The power supply 602 is connected to a noninverting input terminal of the comparator 603. Note that the outside light detecting unit 500 can also be configured by, for example, a phototransistor instead of the photodiode 510. The outside light detecting unit 500 may be monolithically formed with the display unit 200 or may be provided external to the display unit 200. Note that the configuration in which it is monolithically formed with the display unit 200 is more effective because an intensity (of outside light) substantially equal to the intensity of outside light received by the display unit 200 is detected.

In such a configuration, when the photodiode 500 receives outside light, a current Ia of a magnitude according to the intensity of the outside light is provided to the switching control circuit 600. Then, by the current Ia flowing through the resistor 601, a voltage Vk (=Ia×R1) occurs at both ends of the resistor 601. The voltage Vk is provided to the inverting input terminal of the comparator 603 and a reference voltage Vref is provided to the noninverting input terminal of the comparator 603. Then, the comparator 603 compares the voltage Vk with the reference voltage Vref. As a result, if the voltage Vk is greater than or equal to the reference voltage Vref, then the logic level of a display mode selection signal S to be outputted from the comparator 603 is a low level. On the other hand, if the voltage Vk is less than the reference voltage Vref, then the logic level of the display mode selection signal S is a high level. Note that, for convenience of description, in the following, a state in which such an intensity of outside light that generates a voltage Vk greater than or equal to the reference voltage Vref is obtained is referred to as “relatively bright” and a state in which such an intensity of outside light that generates a voltage Vk less than the reference voltage Vref is obtained is referred to as “relatively dark”.

In the configuration shown in FIG. 2, the higher the intensity of outside light, the larger the current Ia. Also, the larger the current Ia, the higher the voltage Vk. Thus, the higher the intensity of outside light, the higher the voltage Vk. Also, as described above, when the voltage Vk is greater than or equal to the reference voltage Vref the logic level of the display mode selection signal S is a low level, and when the voltage Vk is less than the reference voltage Vref the logic level of the display mode selection signal S is a high level. Therefore, when the liquid crystal display device is used in a relatively bright environment, the logic level of the display mode selection signal S is a low level. On the other hand, when the liquid crystal display device is used in a relatively dark environment, the logic level of the display mode selection signal S is a high level. Note that when the logic level of the display mode selection signal S is a high level the aforementioned “first display mode” is selected, and when the logic level of the display mode selection signal S is a low level the aforementioned “second display mode” is selected.

### 1.4 Configuration and Operation of the Gray Scale Signal Generating Unit

1.4.1 Summary of the Gray Scale Signal Generating Unit>

The gray scale signal generating unit 100 includes, as shown in FIG. 1, an output selection circuit 120, a black signal generation circuit 130, a gray scale value converting unit 140, a gray scale value determination table 150, and an input selection circuit 160. A signal line group for transmitting RGB image signals is provided between the output selection circuit 120 and the input selection circuit 160. As shown in FIG. 1, the signal line group is divided into two systems. The output selection circuit 120 is provided with a first output terminal group 121 and a second output terminal group 122, each of which includes a plurality of output terminals. To the first output terminal group 121 is connected one of the two systems of signal line groups. To the second output terminal group 122 is connected the other one of the two systems of signal line groups. Also, the input selection circuit 160 is provided with a first input terminal group 161 and a second input terminal group 162, each of which includes a plurality of input terminals. To the first input terminal group 161 is connected one of the two systems of signal line groups. To the second input terminal group 162 is connected the other one of the two systems of signal line groups. Note that to each of the first input terminal group 161 and the second input terminal group 162 of the input selection circuit 160 is connected a signal line for transmitting a W image signal, in addition to signal lines for transmitting RGB image signals.

In such a configuration as described above, a display mode selection signal S outputted from the switching control circuit 600 is provided to the output selection circuit 120 and the input selection circuit 160. The output selection circuit 120 outputs, based on the display mode selection signal S, digital image signals DA sent from an external source, to one of the two systems of signal line groups. The black signal generation circuit 130 outputs a W image signal whose gray scale value is a value corresponding to black display. The gray scale value converting unit 140 receives RGB image signals outputted from the second output terminal group 122 of the output selection circuit 120. Further, the gray scale value converting unit 140 further generates RGBW image signals to be provided to the input selection circuit 160 and outputs the RGBW image signals, by referring to the gray scale value determination table 150. The input selection circuit 160 receives, based on the display mode selection signal S, RGBW image signals from one of the two systems of signal line groups and outputs the RGBW image signals as gray scale signals DV. The configuration and operation of each component in the gray scale signal generating unit 100 will be described below.

<1.4.2 Output Selection Circuit>

FIG. 3 is a logic circuit diagram showing a configuration of the output selection circuit 120. Although input and output of 8-bit data for each of RGB data are performed in the output selection circuit 120, FIG. 3 only shows components that are involved with the input and output of 1-bit data.

As shown in FIG. 3, the output selection circuit 120 includes an inverter 123 and two AND circuits (a first AND circuit 124 and a second AND circuit 125). An RGB image signal (in this case, referred to as an input signal Din) is provided to one input terminal of the first AND circuit 124. To the other input terminal of the first AND circuit 124 is provided a display mode selection signal S outputted from the switching control circuit 600. Then, a signal indicating an AND of the input signal Din and the display mode selection signal S is outputted from the first AND circuit 124 as an output signal Dout1. An RGB image signal (input signal Din) is provided to one input terminal of the second AND circuit 125. To the other input terminal of the second AND circuit 125 is provided a logic inverted signal of the display mode selection signal S. Then, a signal indicating an AND of the input signal Din and the logic inverted signal of the display mode selection signal S is outputted from the second AND circuit 125 as an output signal Dout2. With such a configuration as described above, the output selection circuit 120 functions as a “one-input two-output” demultiplexer.

In such a configuration, when the logic level of the display mode selection signal S is a high level, the input signal Din appears as the output signal Dout1 from the first AND circuit 124. On the other hand, when the logic level of the display mode selection signal S is a low level, the input signal Din appears as the output signal Dout2 from the second AND circuit 125. Therefore, when the logic level of the display mode selection signal S is a high level, the RGB image signal is outputted from the first output terminal group 121. On the other hand, when the logic level of the display mode selection signal S is a low level, the RGB image signal is outputted from the second output terminal group 122.

<1.4.3 Black Signal Generation Circuit>

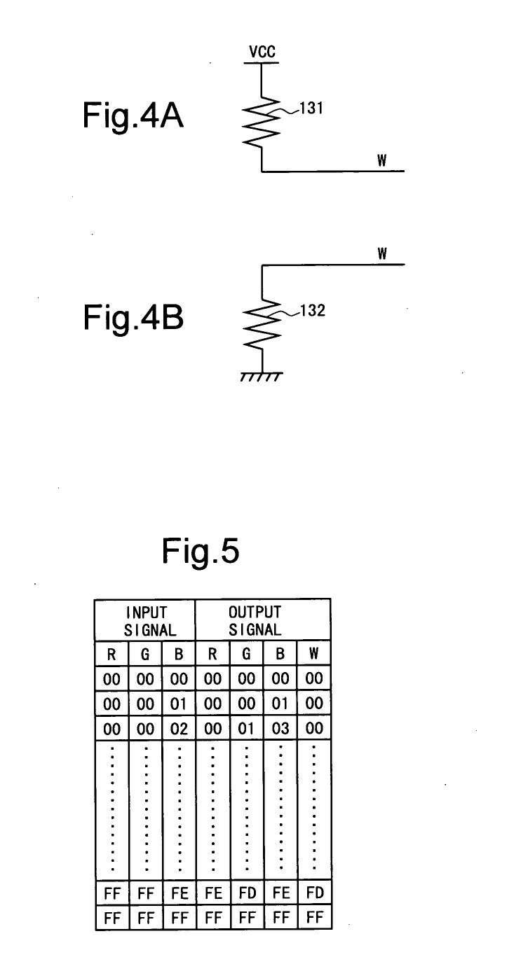

FIG. 4A is a circuit diagram showing a configuration of the black signal generation circuit 130. Note that FIG. 4A only shows a component that is involved with the generation of 1-bit data among data configuring a W image signal. As shown in FIG. 4A, the black signal generation circuit 130 is configured by a resistor 131, one end of which is connected to a power supply. Accordingly, the logic value of a signal outputted from the black signal generation circuit 130 is “1”. By employing the same configuration in the generation of 8-bit data, the logic values of 8-bit data configuring a W image signal are all “1”. That is, a gray scale value indicated by a W image signal is a gray scale value corresponding to black display. In the above-described manner, a W image signal whose gray scale value is set to a value corresponding to black display is outputted from the black signal generation circuit 130.

Note that although in the above description all the logic values of 8-bit data are set to “1”, it is not necessary to set all the logic values to “1”. In other words, the “gray scale value corresponding to black display” should be a gray scale value at which display has a brightness that is one percent or less of that obtained upon on-display. In this case, for data whose logic value is set to “0”, a signal should be outputted from one end of a resistor 132, the other end of which is grounded, as shown in FIG. 4B.

<1.4.4 Gray Scale Value Converting Unit>

Next, the operation of the gray scale value converting unit 140 will be described. The gray scale value converting unit 140 generates RGBW image signals by referring to the gray scale value determination table 150. The gray scale value determination table 150 has such a configuration as shown in FIG. 5. Note that in FIG. 5 the gray scale value of each signal is shown in hexadecimal. As shown in FIG. 5, a combination of the gray scale values of an R image signal, a G image signal, and a B image signal which are input signals (to the gray scale value converting unit) is associated with the gray scale values of an R image signal, a G image signal, a B image signal, and a W image signal which are output signals (from the gray scale value converting unit). Here, the gray scale value of a W image signal which is an output signal is a value corresponding to a Y value representing the luminance component of a pixel. The Y value is calculated based on the gray scale values of image signals of three colors RGB. In the above-described manner, in the gray scale value determination table 150, gray scale values are set in advance such that a desired transmittance can be obtained for each of sub-pixels of RGBW.

The gray scale value converting unit 140 receives, as input signals, RGB image signals outputted from the second output terminal group 122 of the output selection circuit 120. Then, the gray scale value converting unit 140 generates output signals of four colors RGBW (RGBW image signals) from the input signals of three colors RGB by referring to the aforementioned gray scale value determination table 150. The RGBW image signals generated by referring to the gray scale value determination table 150 are outputted from the gray scale value converting unit 140 and provided to the second input terminal group 162 of the input selection circuit 160.

<1.4.5 Input Selection Circuit>

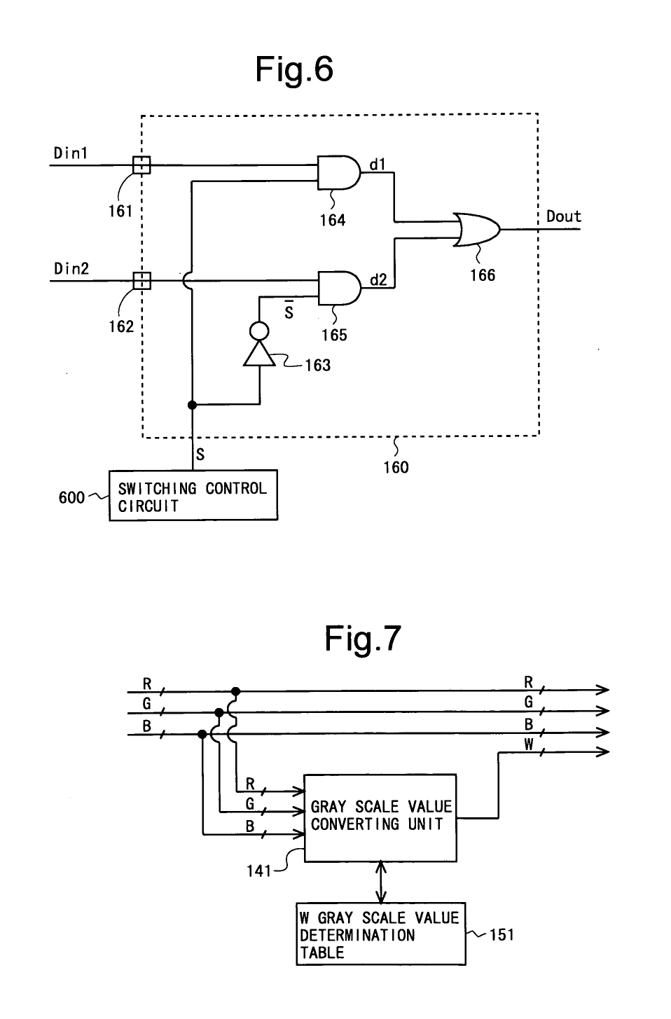

FIG. 6 is a logic circuit diagram showing a configuration of the input selection circuit 160. Although input and output of 8-bit data for each of RGBW data are performed in the input selection circuit 160, FIG. 6 only shows components that are involved with the input and output of 1-bit data.

As shown in FIG. 6, the input selection circuit 160 includes an inverter 163, two AND circuits (a third AND circuit 164 and a fourth AND circuit 165), and an OR circuit 166. An RGB image signal outputted from the output selection circuit 120 or a W image signal outputted from the black signal generation circuit 130 (these image signals are referred to as an input signal Din1) is provided to one input terminal of the third AND circuit 164. To the other input terminal of the third AND circuit 164 is provided a display mode selection signal S outputted from the switching control circuit 600. Then, a signal indicating an AND of the input signal Din1 and the display mode selection signal S is outputted from the third AND circuit 164 as an internal signal d1. An RGBW image signal (in this case, referred to as an input signal Din2) outputted from the gray scale value converting unit 140 is provided to one input terminal of the fourth AND circuit 165. To the other input terminal of the fourth AND circuit 165 is provided a logic inverted signal of the display mode selection signal S. Then, a signal indicating an AND of the input signal Din2 and the logic inverted signal of the display mode selection signal S is outputted from the fourth AND circuit 165 as an internal signal d2. Furthermore, the internal signal d1 is provided to one input terminal of the OR circuit 166 and the internal signal d2 is provided to the other input terminal of the OR circuit 166. Then, a signal indicating an OR of the internal signal d1 and the internal signal d2 is outputted from the OR circuit 166 as an output signal Dout. With such a configuration as described above, the input selection circuit 120 functions as a “two-input one-output” multiplexer.

In such a configuration, when the logic level of the display mode selection signal S is a high level, the input signal Din1 appears as an output signal Dout1 from the third AND circuit 164, however the input signal Din2 does not appear as an output signal Dout1 from the fourth AND circuit 165. On the other hand, when the logic level of the display mode selection signal S is a low level, the input signal Din1 does not appear as an output signal Dout2 from the third AND circuit 164, however the input signal Din2 appears as an output signal Dout2 from the fourth AND circuit 165. Thus, when the logic level of the display mode selection signal S is a high level, the input signal Din1 appears as an output signal Dout from the OR circuit 166. On the other hand, when the logic level of the display mode selection signal S is a low level, the input signal Din2 appears as an output signal Dout from the OR circuit 166. Therefore, when the logic level of the display mode selection signal S is a high level, RGBW image signals inputted through the first input terminal group 161 are outputted from the input selection circuit 160 as gray scale signals DV. On the other hand, when the logic level of the display mode selection signal S is a low level, RGBW image signals inputted through the second input terminal group 162 are outputted from the input selection circuit 160 as gray scale signals DV.

### 1.5 Differences in Operation Between Different Brightnesses

As described above, in the present embodiment, two display modes are provided. Selection of the display modes is made by the switching control circuit 600 switching the logic levels of the display mode selection signal S. Also, the logic level of the display mode selection signal S is determined based on the intensity of outside light. Now, differences in the operation of the liquid crystal display device between different intensities (brightnesses) of outside light will be described.

<1.5.1 Operation in a Relatively Bright Environment>

First, the operation in a case where the liquid crystal display device is used in a relatively bright environment will be described. When the photodiode 510 shown in FIG. 2 receives relatively strong outside light, a relatively large current Ia is provided to the switching control circuit 600 from the outside light detecting unit 500. Then, a relatively high voltage Vk is generated by the current Ia and the resistor 601. Accordingly, the voltage Vk is higher than the reference voltage Vref and thus the logic level of a display mode selection signal S outputted from the switching control circuit 600 is a low level. The display mode selection signal S is provided to the output selection circuit 120 and the input selection circuit 160.

When the logic level of the display mode selection signal S is a low level, in the output selection circuit 120, RGB image signals are outputted through the second output terminal group 122. Then, the gray scale value converting unit 140 generates image signals of four colors RGBW based on the image signals of three colors RGB. The RGBW image signals generated by the gray scale value converting unit 140 are provided to the second input terminal group 162 of the input selection circuit 160. The input selection circuit 160 outputs the RGBW image signals inputted through the second input terminal group 162, as gray scale signals DV. Then, based on the gray scale signals DV outputted from the input selection circuit 160, the source driver 300 applies driving video signals to the source bus lines SL1 to SLn.

As described above, when the liquid crystal display device is used in a relatively bright environment, image display is performed based on RGBW image signals generated by the gray scale value converting unit 140. At this time, the gray scale values of the respective RGBW colors are determined based on the gray scale value determination table 150 as shown in FIG. 5. Thus, the gray scale values are determined such that a desired transmittance can be obtained for all sub-pixels of RGBW. Accordingly, image display using four colors RGBW is performed.

<1.5.2 Operation in a Relatively Dark Environment>

Next, the operation in a case where the liquid crystal display device is used in a relatively dark environment will be described. When the photodiode 510 shown in FIG. 2 receives relatively weak outside light, a relatively small current Ia is provided to the switching control circuit 600 from the outside light detecting unit 500. Then, a relatively low voltage Vk is generated by the current Ia and the resistor 601. Accordingly, the voltage Vk is lower than the reference voltage Vref and thus the logic level of a display mode selection signal S outputted from the switching control circuit 600 is a high level. The display mode selection signal S is provided to the output selection circuit 120 and the input selection circuit 160.

When the logic level of the display mode selection signal S is a high level, in the output selection circuit 120, RGB image signals are outputted through the first output terminal group 121. Then, the RGB image signals are provided to the first input terminal group 161 of the input selection circuit 160. In addition, as described above, the black signal generation circuit 130 generates a W image signal whose gray scale value is a value corresponding to black display. The W image signal is provided to the first input terminal group 161 of the input selection circuit 160. The input selection circuit 160 outputs the RGBW image signals inputted through the first input terminal group 161, as gray scale signals DV. Then, based on the gray scale signals DV outputted from the input selection circuit 160, the source driver 300 applies driving video signals to the source bus lines SL1 to SLn.

As described above, when the liquid crystal display device is used in a relatively dark environment, image display is performed based on RGB image signals sent from an external source and a W image signal generated by the black signal generation circuit 130. At this time, the gray scale value of the W image signal is fixed to a value corresponding to black display. Thus, while the gray scale values of sub-pixels of three primary colors RGB are determined such that a desired transmittance can be obtained, the gray scale value of a sub-pixel of W is fixed to black display. Accordingly, image display using only three primary colors RGB is performed.

### 1.6 Effects

According to the present embodiment, the liquid crystal display device is provided with two display modes and one of the display modes is selected based on the intensity of outside light. Specifically, when the display unit 200 receives relatively strong outside light, the device goes into the second display mode and thus image display using four colors RGBW is performed. Hence, even when the liquid crystal display device is used in a bright environment such as outdoors, light can be allowed to transmit through a sub-pixel of W, enabling to increase the luminance of the display unit 200. On the other hand, when the display unit 200 receives relatively weak outside light, the device goes into the first display mode and thus a sub-pixel of W is fixed to black display and image display using three colors RGB is performed. Hence, when the liquid crystal display device is used in a dark environment such as nighttime, display of a well-defined image with deep colors is performed.

Meanwhile, in a bright environment, image display using four colors RGBW is performed and thus the color of an image as a whole becomes light. However, in such a bright environment, the color becomes light due to the influence of outside light and thus color reproducibility decreases. Hence, even if an image with deep colors is displayed, an effect of improving visibility cannot be obtained much. Thus, the point that the color of an image becomes light in a bright environment is considered to be not particularly problematic. Also, in a dark environment, image display using only three primary colors RGB is performed and thus high luminance cannot be obtained.

However, in a dark environment, even when the luminance is low, an influence on visibility is small and thus this point is also considered to be not particularly problematic.

As described above, according to the present embodiment, when the liquid crystal display device is used in a bright environment, such image display that can obtain high luminance is performed. On the other hand, when the liquid crystal display device is used in a dark environment, such image display that can obtain excellent color reproducibility is performed.

As such, switching between image display where color reproducibility is given priority over luminance and image display where luminance is given priority over color reproducibility can be effectively performed according to the environment where the liquid crystal display device is used.

Accordingly, under the constraint that it is difficult to satisfy both high color reproducibility and high luminance at all times, a liquid crystal display device that achieves a balance between color reproducibility and luminance is achieved.

### 1.7 Variants

<1.7.1 First Variant>

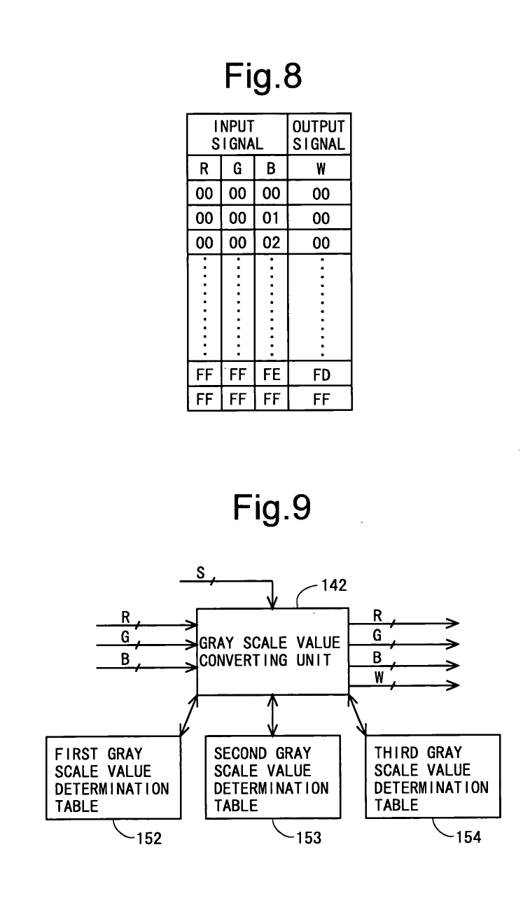

In the first embodiment, in the second display mode, RGBW image signals used for image display are generated by the gray scale value converting unit 140 referring to the gray scale value determination table 150. However, the present invention is not limited thereto. In a liquid crystal display device having sub-pixels of four colors RGBW, for three primary colors RGB, gray scale values indicated by digital image signals DA sent from an external source may be used as they are as gray scale values used upon image display. In such a case, for three colors RGB among four colors RGBW, image signals do not need to be generated by the gray scale value converting unit 140. Thus, the configuration between the second output terminal group 122 of the output selection circuit 120 and the second input terminal group 162 of the input selection circuit 160 may be such as that shown in FIG. 7. In this configuration, a gray scale value converting unit 141 generates only a W image signal based on RGB image signals. Hence, the gray scale value determination table 150 shown in FIG. 5 can be configured to be one as shown in FIG. 8 (W gray scale value determination table 151), whereby a required memory size can be reduced.

<1.7.2 Second Variant>

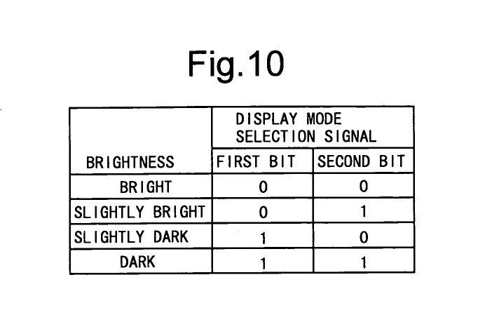

In the first embodiment, although there is only one gray scale value determination table which is referred to by the gray scale value converting unit 140 in the second display mode, the present invention is not limited thereto. For example, as shown in FIG. 9, the configuration can be such that three tables (a first gray scale value determination table 152, a second gray scale value determination table 153, and a third gray scale value determination table 154) are referred to by a gray scale value converting unit 142. Note that in this configuration in order to determine a table to be referred to by the gray scale value converting unit 142, a 2-bit display mode selection signal S is provided to the gray scale value converting unit 142. At this time, the values of the respective bits of the display mode selection signal S may be set according to the intensity of outside light, as shown in FIG. 10, for example. Then, the output selection circuit 120 may be configured such that when both the first bit and the second bit of the display mode selection signal S are “1” RGB image signals are outputted through the first output terminal group 121, and otherwise RGB image signals are outputted through the second output terminal group 122. Accordingly, when it is bright, when it is slightly bright, and when it is slightly dark, the first gray scale value determination table 152, the second gray scale value determination table 153, and the third gray scale value determination table 154 are respectively referred to, to generate RGBW image signals and image display using four colors RGBW can be performed based on the RGBW image signals. As such, image display can be performed in various display modes according to brightness.

### 2. Second Embodiment

### 2.1 Overall Configuration and Operation

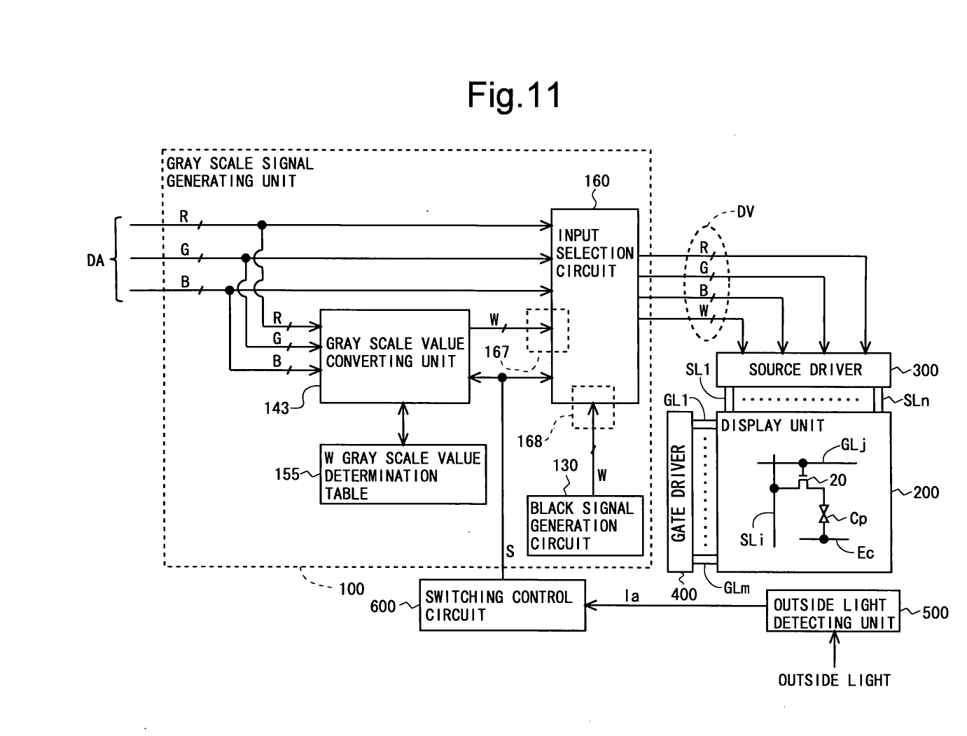

FIG. 11 is a block diagram showing an overall configuration of a liquid crystal display device according to a second embodiment of the present invention. In the present embodiment, unlike the first embodiment, an output selection circuit 120 is not provided in a gray scale signal generating unit 100. Hence, as shown in FIG. 11, digital image signals (RGB image signals) DA sent from an external source are provided to an input selection circuit 160 and a gray scale value converting unit 143. The input selection circuit 160 includes a first input terminal 167 for receiving a W image signal outputted from the gray scale value converting unit 143; and a second input terminal 168 for receiving a W image signal outputted from a black signal generation circuit 130. Also, the gray scale value converting unit 143 is configured to refer to a W gray scale value determination table 155 as shown in FIG. 8. To the gray scale value converting unit 143 is provided a display mode selection signal S. Note that description of the same components as those in the first embodiment is not given.

In such a configuration as described above, a switching control circuit 600 outputs a display mode selection signal S for selecting one of the first display mode and the second display mode, based on the magnitude of a current Ia outputted from an outside light detecting unit 500. The gray scale value converting unit 143 receives RGB image signals sent from an external source. Further, the gray scale value converting unit 143 generates a W image signal to be provided to the input selection circuit 160 and outputs the W image signal, based on the display mode selection signal S. At that time, the W gray scale value determination table 155 is referred to by the gray scale value converting unit 143. The black signal generation circuit 130 outputs a W image signal whose gray scale value is a value corresponding to black display. The input selection circuit 160 receives RGB image signals sent from an external source and receives, based on the display mode selection signal S, a W image signal from one of the first input terminal 167 and the second input terminal 168.

### 2.2 Differences in Operation Between Different Brightnesses

Next, differences in operation between different brightnesses in the present embodiment will be described.

<2.2.1 Operation in a Relatively Bright Environment>

First, the operation in a case where the liquid crystal display device is used in a relatively bright environment will be described. When the outside light detecting unit 500 receives relatively strong outside light, a relatively large current Ia is provided to the switching control circuit 600 from the outside light detecting unit 500. At this time, as with the first embodiment, the logic level of a display mode selection signal S outputted from the switching control circuit 600 is a low level. The display mode selection signal S is provided to the gray scale value converting unit 143 and the input selection circuit 160.

When the logic level of the display mode selection signal S is a low level, the gray scale value converting unit 143 generates a W image signal by referring to the W gray scale value determination table 155, based on image signals of three colors RGB. The W image signal generated by the gray scale value converting unit 143 is provided to the first input terminal 167 of the input selection circuit 160. The input selection circuit 160 receives RGB image signals sent from an external source and the W image signal inputted through the first input terminal 167 and outputs the signals as gray scale signals DV, based on the display mode selection signal S. Then, based on the gray scale signals DV outputted from the input selection circuit 160, a source driver 300 applies driving video signals to source bus lines SL1 to SLn.

As described above, when the liquid crystal display device is used in a relatively bright environment, image display is performed based on RGB image signals sent from an external source and a W image signal generated by the gray scale value converting unit 143. At this time, the gray scale value of W is determined based on the W gray scale value determination table 155 as shown in FIG. 8. Thus, the gray scale values are determined such that a desired transmittance can be obtained not only for sub-pixels of three primary colors RGB but also for a sub-pixel of W. Accordingly, image display using four colors RGBW is performed.

<2.2.2 Operation in a Relatively Dark Environment>

Next, the operation in a case where the liquid crystal display device is used in a relatively dark environment will be described. When the outside light detecting unit 500 receives relatively weak outside light, a relatively small current Ia is provided to the switching control circuit 600 from the outside light detecting unit 500. At this time, as with the first embodiment, the logic level of a display mode selection signal S outputted from the switching control circuit 600 is a high level. The display mode selection signal S is provided to the gray scale value converting unit 143 and the input selection circuit 160.

When the logic level of the display mode selection signal S is a high level, the gray scale value converting unit 143 does not generate a W image signal. The black signal generation circuit 130 generates, as with the first embodiment, a W image signal whose gray scale value is a value corresponding to black display and the W image signal is provided to the second input terminal 168 of the input selection circuit 160. The input selection circuit 160 receives RGB image signals sent from an external source and the W image signal inputted through the second input terminal 168 and outputs the signals as gray scale signals DV, based on the display mode selection signal S. Then, based on the gray scale signals DV outputted from the input selection circuit 160, the source driver 300 applies driving video signals to the source bus lines SL1 to SLn.

As described above, when the liquid crystal display device is used in a relatively dark environment, image display is performed based on RGB image signals sent from an external source and a W image signal generated by the black signal generation circuit 130. At this time, the gray scale value of the W image signal is fixed to a value corresponding to black display. Thus, while the gray scale values of sub-pixels of three primary colors RGB are determined such that a desired transmittance can be obtained, the gray scale value of a sub-pixel of W is fixed to black display. Accordingly, image display using only three primary colors RGB is performed.

### 2.3 Effects

In the present embodiment, too, as with the first embodiment, when the liquid crystal display device is used in a bright environment such image display that can obtain high luminance is performed, and when the liquid crystal display device is used in a dark environment such image display that can obtain excellent color reproducibility is performed. Here, in the present embodiment, unlike the first embodiment, an output selection circuit 120 is not provided in the gray scale signal generating unit 100. Thus, a liquid crystal display device that achieves a balance between color reproducibility and luminance can be achieved with a simple configuration.

### 3. Third Embodiment

### 3.1 Overall Configuration and Operation

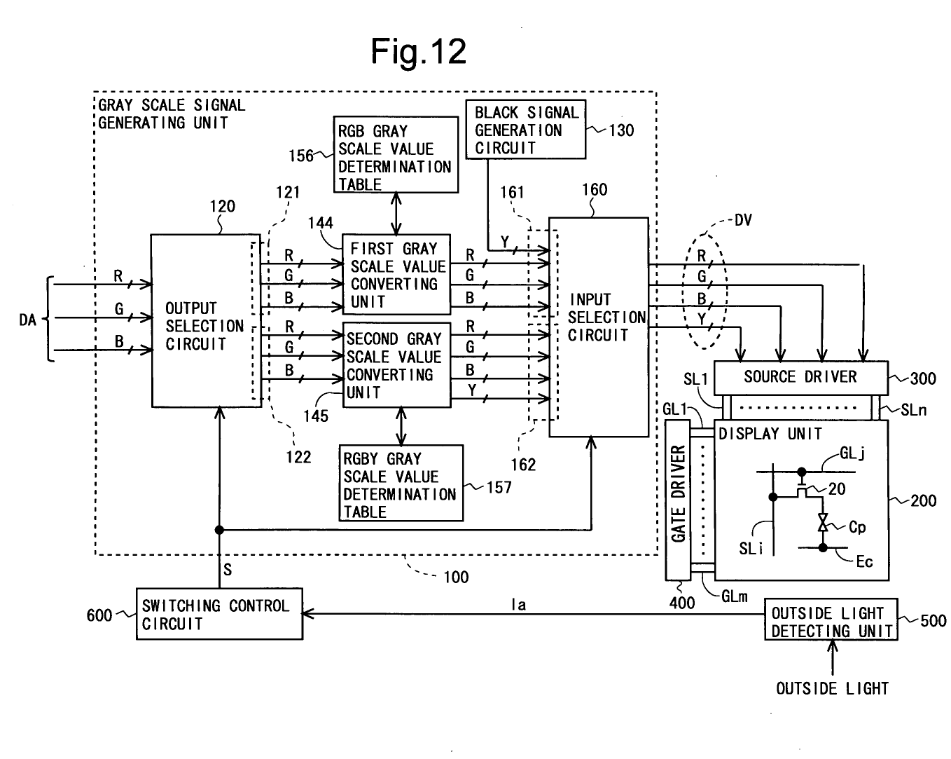

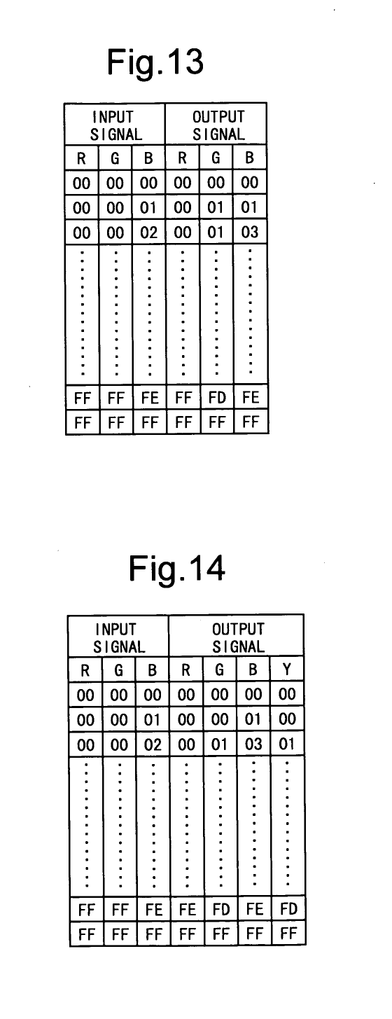

FIG. 12 is a block diagram showing an overall configuration of a liquid crystal display device according to a third embodiment of the present invention. In the present embodiment, unlike the first embodiment, each pixel is configured by sub-pixels of three primary colors RGB and a sub-pixel of Y (yellow) as shown in FIG. 15C. In a gray scale signal generating unit 100 two gray scale value converting units (a first gray scale value converting unit 144 and a second gray scale value converting unit 145) are provided. In addition, in the gray scale signal generating unit 100 are provided an RGB gray scale value determination table 156 for the first gray scale value converting unit 144 to refer to and an RGBY gray scale value determination table 157 for the second gray scale value converting unit 145 to refer to. As shown in FIG. 13, in the RGB gray scale value determination table 156, a combination of the gray scale values of an R image signal, a G image signal, and a B image signal which are input signals to the first gray scale value converting unit 144 is associated with the gray scale values of an R image signal, a G image signal, and a B image signal which are output signals from the first gray scale value converting unit 144. As shown in FIG. 14, in the RGBY gray scale value determination table 157, a combination of the gray scale values of an R image signal, a G image signal, and a B image signal which are input signals to the second gray scale value converting unit 145 is associated with the gray scale values of an R image signal, a G image signal, a B image signal, and a Y image signal which are output signals from the second gray scale value converting unit 145. Note that description of the same components as those in the first embodiment is not given.

In such a configuration as described above, a switching control circuit 600 outputs a display mode selection signal S in the same manner as in the first embodiment. The display mode selection signal S is provided to an output selection circuit 120 and an input selection circuit 160. The output selection circuit 120 outputs RGB image signals sent from an external source to one of two systems of signal line groups. At that time, when the logic level of the display mode selection signal S is a high level the RGB image signals are outputted from a first output terminal group 121, and when the logic level of the display mode selection signal S is a low level the RGB image signals are outputted from a second output terminal group 122. The first gray scale value converting unit 144 receives RGB image signals outputted from the first output terminal group 121 of the output selection circuit 120. Further, the first gray scale value converting unit 144 generates RGB image signals to be provided to the input selection circuit 160 and outputs the RGB image signals, by referring to the RGB gray scale value determination table 156. The second gray scale value converting unit 145 receives RGB image signals outputted from the second output terminal group 122 of the output selection circuit 120. Further, the second gray scale value converting unit 145 generates RGBW image signals to be provided to the input selection circuit 160 and outputs the RGBW image signals, by referring to the RGBY gray scale value determination table 157. A black signal generation circuit 130 outputs a W image signal whose gray scale value is a value corresponding to black display. The input selection circuit 160 receives RGBW image signals and outputs them as gray scale signals DV. At that time, when the logic level of the display mode selection signal S is a high level the input selection circuit 160 receives RGBW image signals inputted through a first input terminal group 161, and when the logic level of the display mode selection signal S is a low level the input selection circuit 160 receives RGBW image signals inputted through a second input terminal group 162.

### 3.2 Effects

In the present embodiment, each pixel is configured by sub-pixels of RGBY. In the case in which, as a sub-pixel of a color other than RGB, a sub-pixel of a color other than W (white) is thus included, when the color other than RGB is illuminated, a color shift occurs. Thus, upon image display using four colors RGBY, the gray scale values of RGB image signals need to be converted. In the present embodiment, when the logic level of a display mode selection signal S is a low level (when in the second display mode), RGBY image signals are generated by referring to the RGBY gray scale value determination table 157 as shown in FIG. 14. Hence, by inputting in advance favorable gray scale values into the RGBY gray scale value determination table 157, conversion of the gray scale values of RGB image signals and generation of a Y image signal can be favorably performed and thus excellent display quality can be obtained upon image display using four colors RGBY.

Also, the liquid crystal display device according to the present embodiment is configured to obtain excellent colors by using four colors RGBY. Thus, RGB color filters that are different than those used in a liquid crystal display device having pixels of a configuration shown in FIG. 15A are used. Therefore, when image display is performed using only three primary colors RGB with Y being black display, too, conversion of the gray scale values of RGB image signals is required. In the present embodiment, when the logic level of a display mode selection signal S is a high level (when in the first display mode), RGB image signals are generated by referring to the RGB gray scale value determination table 156 as shown in FIG. 13. Hence, by inputting in advance favorable gray scale values into the RGB gray scale value determination table 156, conversion of the gray scale values of RGB image signals can be favorably performed and thus excellent display quality can be obtained upon image display using three colors RGB.

As described above, according to the present embodiment, in a configuration including, as a sub-pixel of a color other than RGB, a sub-pixel of a color other than W (white), too, a liquid crystal display device that achieves a balance between color reproducibility and luminance without degrading display quality is achieved.

### 4. Others>

Although, in the above-described embodiments, description is made taking, as examples, liquid crystal display devices in which each pixel is configured by sub-pixels of four colors RGBW or RGBY, the present invention is not limited thereto. The present invention can be applied, for example, to liquid crystal display devices in which each pixel is configured by sub-pixels of four colors RGBC (C is cyan). The present invention can also be applied to liquid crystal display devices in which each pixel is configured by sub-pixels of five colors, as shown in FIG. 15D.

1. A display device that includes a display unit having a plurality of video signal lines and pixels, each of which is configured by sub-pixels of four or more colors including three colors, red, green, and blue, and that displays an image on the display unit by applying driving video signals generated based on gray scale values of the respective sub-pixels, to the plurality of video signal lines, the display device comprising:
an outside light detecting unit for detecting an intensity of outside light;
a display mode selecting unit for selecting one of a first display mode and a second display mode according to the intensity of outside light detected by the outside light detecting unit, the first display mode where image display is performed such that a gray scale value of a sub-pixel of at least one color among sub-pixels of colors other than the three colors, red, green, and blue, is a predetermined value, the second display mode where image display is performed such that a gray scale value of a sub-pixel of a color other than the three colors, red, green, and blue, is a value determined based on gray scale values indicated by RGB image signals sent from an external source;
a gray scale signal generating unit for receiving the RGB image signals and generating, according to the display mode selected by the display mode selecting unit, gray scale signals indicating gray scale values of the respective sub-pixels; and
a video signal line drive circuit for applying the driving video signals to the plurality of video signal lines based on the gray scale signals generated by the gray scale signal generating unit, wherein
the display mode selecting unit selects the first display mode when the intensity of outside light is less than a predetermined reference intensity, and selects the second display mode when the intensity of outside light is greater than or equal to the reference intensity.

2. The display device according to claim 1, wherein when the first display mode is selected by the display mode selecting unit, the gray scale signal generating unit generates the gray scale signals such that a gray scale value of a sub-pixel of at least one color among sub-pixels of colors other than the three colors, red, green, and blue, is a value corresponding to black display.

3. The display device according to claim 1, wherein each of the pixels configuring the display unit is configured by sub-pixels of red, green, blue, and white.

4. The display device according to claim 1, wherein each of the pixels configuring the display unit is configured by sub-pixels of red, green, and blue and a sub-pixel of at least one of yellow and cyan.

5. The display device according to claim 1, further comprising a gray scale value determination table for storing information indicating a correspondence relationship between the gray scale values indicated by the RGB image signals and a gray scale value of a sub-pixel of a color other than the three colors, red, green, and blue, among the sub-pixels of four or more colors, wherein
when the second display mode is selected by the display mode selecting unit, the gray scale signal generating unit generates the gray scale signals based on the gray scale value determination table.

6. The display device according to claim 5, wherein the gray scale value determination table further stores information indicating a correspondence relationship between the gray scale values indicated by the RGB image signals and gray scale values of sub-pixels of red, green, and blue.

7. The display device according to claim 5, further comprising a plurality of gray scale value determination tables, wherein
when the second display mode is selected by the display mode selecting unit, the gray scale signal generating unit selects any one of the plurality of gray scale value determination tables according to the intensity of outside light and generates the gray scale signals based on the selected gray scale value determination table.

8. The display device according to claim 1, wherein the outside light detecting unit is a photodiode or phototransistor.

9. A display method for a display device that includes a display unit having a plurality of video signal lines and pixels, each of which is configured by sub-pixels of four or more colors including three colors, red, green, and blue, and that displays an image on the display unit by applying driving video signals generated based on gray scale values of the respective sub-pixels, to the plurality of video signal lines, the display method comprising:
an outside light detecting step of detecting an intensity of outside light;
a display mode selecting step of selecting one of a first display mode and a second display mode according to the intensity of outside light detected in the outside light detecting step, the first display mode where image display is performed such that a gray scale value of a sub-pixel of at least one color among sub-pixels of colors other than the three colors, red, green, and blue, is a predetermined value, the second display mode where image display is performed such that a gray scale value of a sub-pixel of a color other than the three colors, red, green, and blue, is a value determined based on gray scale values indicated by RGB image signals sent from an external source;
a gray scale signal generating step of receiving the RGB image signals and generating, according to the display mode selected in the display mode selecting step, gray scale signals indicating gray scale values of the respective sub-pixels; and
a video signal line driving step of applying the driving video signals to the plurality of video signal lines based on the gray scale signals generated in the gray scale signal generating step, wherein
in the display mode selecting step, the first display mode is selected when the intensity of outside light is less than a predetermined reference intensity and the second display mode is selected when the intensity of outside light is greater than or equal to the reference-intensity.

10. The display method according to claim 9, wherein in the gray scale signal generating step, when the first display mode is selected in the display mode selecting step, the gray scale signals are generated such that a gray scale value of a sub-pixel of at least one color among sub-pixels of colors other than the three colors, red, green, and blue, is a value corresponding to black display.

11. The display method according to claim 9, wherein each of the pixels configuring the display unit is configured by sub-pixels of red, green, blue, and white.

12. The display method according to claim 9, wherein each of the pixels configuring the display unit is configured by sub-pixels of red, green, and blue and a sub-pixel of at least one of yellow and cyan.

13. The display method according to claim 9, in the gray scale signal generating step, when the second display mode is selected in the display mode selecting step, the gray scale signals are generated based on a gray scale value determination table which is provided in advance to store information indicating a correspondence relationship between the values indicated by the RGB image signals and a gray scale value of a sub-pixel of a color other than the three colors, red, green, and blue, among the sub-pixels of four or more colors.

14. The display method according to claim 13, wherein the gray scale value determination table further stores information indicating a correspondence relationship between the gray scale values indicated by the RGB image signals and gray scale values of sub-pixels of red, green, and blue.

15. The display method according to claim 13, wherein
a plurality of gray scale value determination tables are provided in advance, and
in the gray scale signal generating step, when the second display mode is selected in the display mode selecting step, any one of the plurality of gray scale value determination tables is selected according to the intensity of outside light and the gray scale signals are generated based on the selected gray scale value determination table.

16. The display method according to claim 9, wherein in the outside light detecting step, based on outside light received by a photodiode or phototransistor, an intensity of the outside light is detected.
